(19) United States
(12) Patent Application Publication
(10) Pub. No.: US 2026/0170974 A1
(43) Pub. Date: Jun. 18, 2026

(54) Method and Model for Teaching Laparoscopic Artificial Insemination

(71) Applicant: Lincoln Memorial University, Harrogate, TN (US)

(72) Inventors: Lynda Miller, Harrogate (TN); Hannah Bonnema, Harrogate, TN (US); Robert Brockman, Harrogate, TN (US)

(73) Assignee: Lincoln Memorial University, Harrogate, TN (US)

(21) Appl. No.: 19/420,113

(22) Filed: Dec. 15, 2025

Related U.S. Application Data
(60) Provisional application No. 63/733,852, filed on Dec. 13, 2024.

(51) Int. Cl. G09B 23/30

(52) U.S. Cl. CPC G09B 23/30

(57) ABSTRACT

A training model for laparoscopic procedures of an animal is provided that includes a base portion having a support surface with a mounting region sized and shaped to correspond to a durasl-ventral outline of an abdominal region of the animal. The mounting region is configured to resemble an internal dorsal surface of an abdominal cavity of the animal. At least one replica organ is mounted along the mounting region in an anatomically corresponding orientation. A cover portion includes an interior shell defining an inner concave surface sized and shaped to resemble an inflated abdominal cavity and an exterior surface sized and shaped to resemble an exterior abdominal surface of the animal. The exterior surface is configured to resemble an external skin surface of the animal.

### CROSS-REFERENCE TO RELATED APPLICATIONS

This Application claims the benefit of U.S. Provisional Patent Application Ser. No. 63/733,852, filed on Dec. 13, 2024, the content of which is incorporated in its entirety herein by reference.

### STATEMENT REGARDING FEDERALLY SPONSORED RESEARCH OR DEVELOPMENT

Not Applicable.

### FIELD OF INVENTION

The present general inventive concept pertains to animal husbandry and veterinary teaching, and more particularly to an anatomical teaching model and method for teaching laparoscopic artificial insemination, for example in ovine animals or other small ruminants.

### BACKGROUND

In the field of animal husbandry, it is common to attempt breeding of specific animals using artificial insemination. However, in the case of small ruminant animals, i.e., sheep, goats, etc., traditional transcervical artificial insemination is often difficult due to the unique anatomically tortuous cervix found in these animals. Thus, laparoscopic artificial insemination (“LAI”) is often employed as a means of conducting artificial insemination in these types of animals. LAI is an intrauterine method of insemination that employs the use of traditional laparoscopic tools and techniques to allow a user to access the reproductive anatomy of an animal via the abdominal wall. Typically, an animal patient (“patient”) undergoing LAI is sedated, and its abdominal cavity is filled with gas to create a convenient space within the abdomen to access the reproductive anatomy therein. One or more tools is then inserted into the inflated abdominal cavity to accomplish the desired intrauterine insemination. Most commonly, such tools may include at least one camera to facilitate visibility within the abdominal cavity and at least one syringe device configured to allow injection of viable semen directly into the uterus of the animal. In traditional LAI procedures, one or more trocar devices are used to create small entry points into the abdominal wall to allow for convenient insertion of the camera and syringe device. Following the LAI procedure, the patient's abdominal wall may be at least partially deflated and the trocars may be removed from the patient's abdominal wall, leaving only small incision sites for post-surgical care.

The use of LAI offers several advantages over more traditional transcervical artificial insemination methods. For example, through LAI, processed semen may be used more efficiently, thus leading to higher rates of successful pregnancy in the animal patients and/or higher numbers of pregnancies using a single semen sample. However, successful use of LAI also depends on proper use of the associated laparoscopic tools and a thorough knowledge of the reproductive anatomy of the animal. Improper use of LAI can result in several complications, including failed impregnation, patient morbidity, and patient mortality.

In the field of veterinary medicine, it is often desirable for students to practice certain techniques and procedures in order to gain a better understanding of the technique or procedure prior to performing it in a real-world clinical setting. However, in the case of LAI, the use of live animals for practice poses a number of obstacles. For example, the process of sedating an animal and inflating the abdominal cavity for laparoscopy poses inherent risk to the health and safety of the animal, especially if performed incorrectly. Laparoscopy also results in discomfort and stress to the animal when performed unnecessarily. Furthermore, it is important when performing LAI to ensure that the patient animal is in the appropriate stage of its menstrual cycle in order to ensure successful impregnation. Thus, the availability of live patient animals for which it is appropriate for LAI to be performed is not always consistent, even in an environment in which many small ruminant animals are present.

The use of simulated teaching models designed to resemble a portion of an animal patient offers a benign, perpetually available method for teaching students to perform LAI. However, in the known prior art, a significant limitation exists in that an anatomically accurate teaching model of an abdominal cavity of a female small ruminant patient that can reliably and repeatedly be used to practice LAI has heretofore not been developed. In fact, a significant limitation exists in the field of veterinary teaching in general, in that anatomically accurate teaching models of animal abdominal cavities in general are not common. Accordingly, there exists a desire to produce a simulated and anatomically accurate teaching model of an abdominal portion of an animal, and in particular a female small ruminant animal, that can be used, for example, to teach and/or practice LAI. There exists a further desire to produce such a teaching model with easily and conveniently repairable and replaceable parts, such that the teaching model may be maintained absent the need for full replacement of the entire teaching model.

### BRIEF SUMMARY OF THE INVENTION

According to various example embodiments of the present general inventive concept, an a model for teaching laparoscopic artificial insemination is provided that comprises an artificial abdominal portion of an animal that bears close resemblance, both in shape and feel, to a natural abdominal portion of a real animal. Various example embodiments of the present general inventive concept may resemble, for example, an abdominal portion of a small ruminant that has been at least partially prepared for a laparoscopic procedure. For example, in certain embodiments, the model may include an interior cavity sized, shaped, and positioned within the model to resemble an inflated gas cavity of the type present in a small ruminant abdomen that has been inflated in anticipation of the receipt of one or more laparoscopic tools. In various embodiments, one or more trocar devices may be provided extending from an exterior surface of the model to an interior of the abdominal cavity to provide access to the interior of the abdominal cavity. In various embodiments, the model may be selectively repositionable between a supine position and a Trendelenburg position, of the type commonly used in performing LAI on a live patient animal. Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved, in various embodiments, by providing a training model for laparoscopic procedures of an animal that comprises a base portion including a support surface having a mounting region sized and shaped to correspond to a durasl-ventral outline of an abdominal region of the animal. In various embodiments, the mounting region may be configured to resemble an internal dorsal surface of an abdominal cavity of the animal. At least one replica organ may be mounted along the mounting region in an anatomically corresponding orientation. A cover portion may be provided including an interior shell defining an inner concave surface sized and shaped to resemble an inflated abdominal cavity and an exterior surface sized and shaped to resemble an exterior abdominal surface of the animal. In various embodiments, the exterior surface may be configured to resemble an external skin surface of the animal.

Additional aspects and advantages of the present general inventive concept may be achieved by providing a training model of the type discussed above, in which the support surface is reconfigurable between a substantially horizontal supine orientation and a tail-elevated Trendelenburg orientation by elevating a caudal end of the support surface relative to a cranial end of the support surface. In various embodiments, the training model may further comprise a hinge at the cranial end and a positionable stand at the caudal end to set an inclination of the support surface corresponding to a Trendelenburg angle. In various embodiments, the at least one replica organ may include an artificial uterus comprising a rigid central core and a soft, flexible outer layer having a flesh-toned coloration. In various embodiments, the artificial uterus may comprise a vaginal canal portion, a uterine body, and a pair of uterine horns extending in a Y-shaped configuration. In various embodiments, the artificial uterus may further comprise fallopian tubes and ovaries positioned at cranial ends of the uterine horns.

Additional aspects and advantages of the present general inventive concept may be achieved by providing a training model of the type discussed above, in which the interior shell comprises open-cell foam that defines a concave inner surface approximating the inflated abdominal cavity size and shape. In various embodiments, the cover portion may be removably fastened to the base portion with releasable fasteners. In various embodiments, the at least one replica organ may include a flexible and at least partially translucent artificial bladder. In various embodiments, the base portion may further comprise a compliant base layer overlying the support surface to replicate an interior dorsal abdominal surface. In various embodiments, the support surface may have a planform perimeter approximating a dorsal-ventral outline of a small ruminant abdomen. In various embodiments, the training model may further comprise at least one trocar device received through the cover portion to provide access to an interior of the cover portion for laparoscopic tools. In various embodiments, the at least one trocar device may include two trocar devices sized to receive a laparoscope and an injection tool for simulated intrauterine deposition. In various embodiments, the cover portion may include an exterior covering over the shell configured to resemble an external skin surface. In various embodiments, the exterior covering may comprise a soft, flexible elastomer having a flesh-toned coloration to simulate abdominal wall puncture and instrument handling.

Additional aspects and advantages of the present general inventive concept may be achieved by providing a training model of the type discussed above, in which the replica organs and cover portion are modular and replaceable to vary anatomy, positioning, or user difficulty level. In various embodiments, the training model may be sized and configured to accept insertion of a fiberoptic camera through a first trocar and an injection tool through a second trocar to simulate guided intrauterine injection.

Additional aspects and advantages of the present general inventive concept may be achieved by practicing various operations associated with a method of training laparoscopic artificial insemination in a female small ruminant using a simulation apparatus. In various embodiments, the method may comprise such operations as configuring a base portion and cover portion of the apparatus to encapsulate replica organs including an artificial uterus and a bladder within an interior cavity that simulates a gas-inflated abdominal cavity. In various embodiments, the method may comprise positioning the apparatus in a supine or tail-elevated Trendelenburg orientation. At least one trocar device may be inserted through an exterior of the cover portion into the interior cavity. A laparoscope may be advanced through a first trocar and an injection tool through a second trocar. Thus, under endoscopic visualization, the artificial uterus may be contacted and pierced with the injection tool at a location corresponding to a uterine body or horn to simulate intrauterine semen deposition. In various embodiments, additional operations may be practiced, such as adjusting a trocar insertion angle and a trocar insertion depth using indicators on a trocar device to simulate safe insertion technique.

Additional aspects and advantages of the present general inventive concept may be achieved by providing a kit for assembling a small-ruminant laparoscopic artificial insemination training model. In various embodiments, the kit may comprise a support surface configured to reconfigure between supine and Trendelenburg orientations, a base layer, a mounting layer, a set of replica organs including an artificial uterus having a rigid core and a soft outer layer and a flexible bladder, an interior shell shaped to define an inflated abdominal cavity, an exterior covering sized to replicate an abdominal wall, and at least two trocar devices sized for a laparoscope and an injection tool. In various embodiments, the components may be removably connectable to enable assembly, disassembly, cleaning, and replacement while maintaining an anatomically representative arrangement for laparoscopic artificial insemination training.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a perspective view of a model for teaching laparoscopic artificial insemination according to an example embodiment of the present general inventive concept;

FIG. 2 illustrates a partially exploded, partial perspective view of the model of FIG. 1;

FIG. 3 illustrates a partially exploded perspective view of the model of FIG. 1;

FIG. 4 illustrates another perspective view of the model of FIG. 1;

FIG. 5 illustrates a perspective view of a mold and component used in the fabrication of an artificial organ according to an example embodiment of the present general inventive concept;

FIG. 6, illustrates an exploded perspective view of a cover portion of a model for teaching laparoscopic artificial insemination according to an example embodiment of the present general inventive concept;

FIG. 7 illustrates a perspective view showing an underside of the cover portion shown in FIG. 6; and

FIG. 8 illustrates a perspective view showing various operations of a method for training laparoscopic artificial insemination according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a model for teaching laparoscopic artificial insemination is provided that comprises an artificial abdominal portion of an animal that bears close resemblance, both in shape and feel, to a natural abdominal portion of a real animal. In accordance with various features and aspects of the present general inventive concept, in several embodiments, the model for teaching laparoscopic artificial insemination, or “model,” resembles an abdominal portion of a small ruminant that has been at least partially prepared for a laparoscopic procedure. For example, in certain embodiments, the model includes an interior cavity sized, shaped, and positioned within the model to resemble an inflated gas cavity of the type present in a small ruminant abdomen that has been inflated in anticipation of the receipt of one or more laparoscopic tools. In various embodiments, one or more trocar devices are provided extending from an exterior surface of the model to an interior of the abdominal cavity to provide access to the interior of the abdominal cavity. In various embodiments, the model is selectively repositionable between a supine position and a Trendelenburg position, of the type commonly used in performing LAI on a live patient animal. According to various additional example embodiments of the present general inventive concept, one or more methods of manufacturing a model, configuring the model for use, and use of the model to perform LAI is also provided.

As used in the following description, various components of the model may be identified with terminology corresponding to those portions of a real animal for which the components of the model are meant to replicate. For example, it will be understood that, as used herein, the term “abdomen” may be used with reference to the model described herein to refer to an artificial abdomen as replicated by the model, rather than an actual abdomen of a real animal. Likewise, terms such as “uterus,” “skin,” “bladder,” and “abdominal wall” may be used herein to refer to those corresponding portions of the model for which the identified components are meant to replicate. Thus, to the extent such anatomical terms are used in reference to components of the model, those of skill in the art will recognize that such terms may be used to refer either to a “real” animal component or to an “artificial” component of the model which is provided to replicate such real animal component.

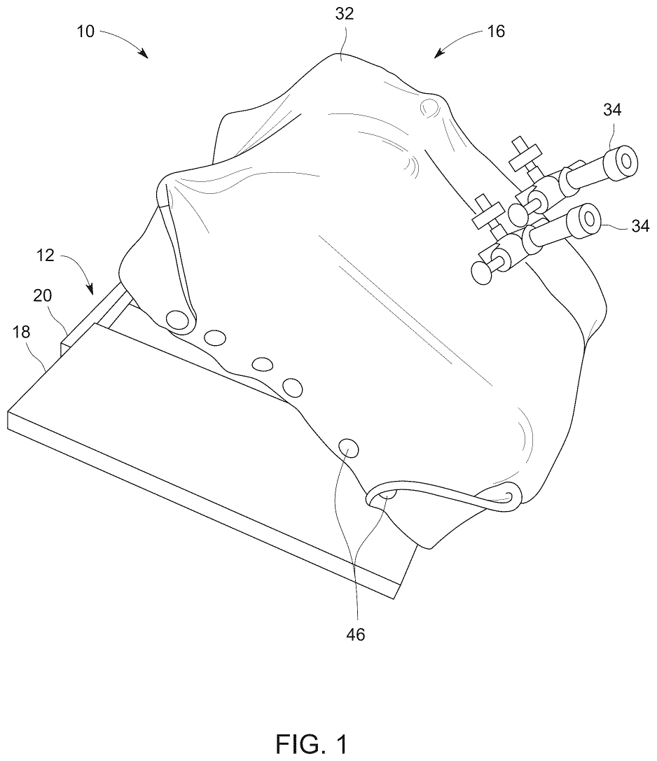

One embodiment of a model constructed in accordance with various features of the present general inventive concept is illustrated in the accompanying figures. With initial reference to FIGS. 1-4, in one embodiment, a model 10 is provided defining generally a base portion 12 including a support surface 14 for supporting one or more replica organs 24, 26 of an interior abdominal portion of a small ruminant. As will be described in further detail hereinbelow, the replica organs may be provided and arranged in an orientation and spatial relationship with one another so as to approximate the configuration of such corresponding organs within the abdominal cavity of an animal patient. Additionally, a cover portion 16 is provided surrounding and substantially encapsulating the replica organs in cooperation with the base portion 12. As will be described in further detail hereinbelow, in various embodiments, the cover portion 16 includes an interior defining a cavity surrounding the replica organs, the cavity being sized and shaped to resemble an inflated abdomen cavity of a small ruminant. An exterior of the cover portion 16 is sized and shaped to resemble an outer skin surface of an abdomen of a small ruminant.

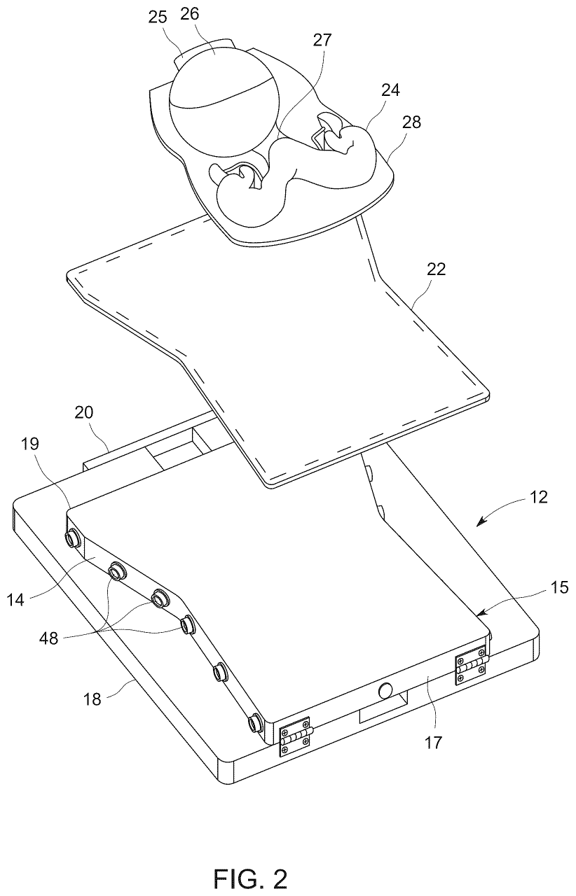

With reference to FIG. 2, in the illustrated embodiment, the support surface 14 of the base portion 12 is defined by a substantially rigid sheet of planar material, such as wood, polymer, or the like, which in several embodiments defines a perimeter area 15 shaped to resemble a dorsal/ventral outline of a small ruminant animal's abdomen. In the illustrated embodiment, the support surface 14 is fabricated from a sheet of composite wood material. Also, in the illustrated embodiment, the perimeter area 15 is defined by the perimeter edge of the support surface 14. However, it will be understood that, in other embodiments, the perimeter area may be defined as a smaller area extending along only a portion of the support surface 14. In other words, in some embodiments, the support surface 14 may extend beyond the perimeter area 15 to define a broader “support surface” for the model 10.

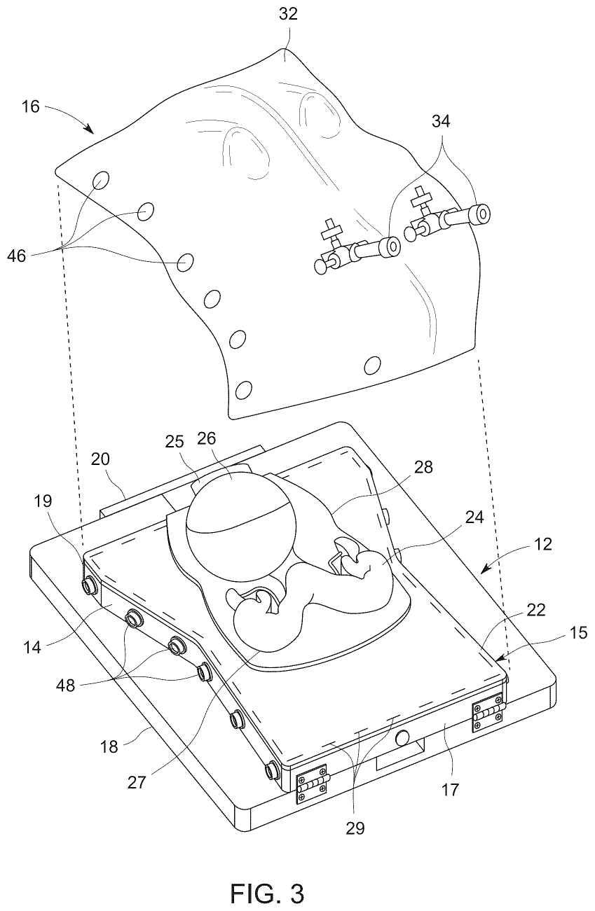

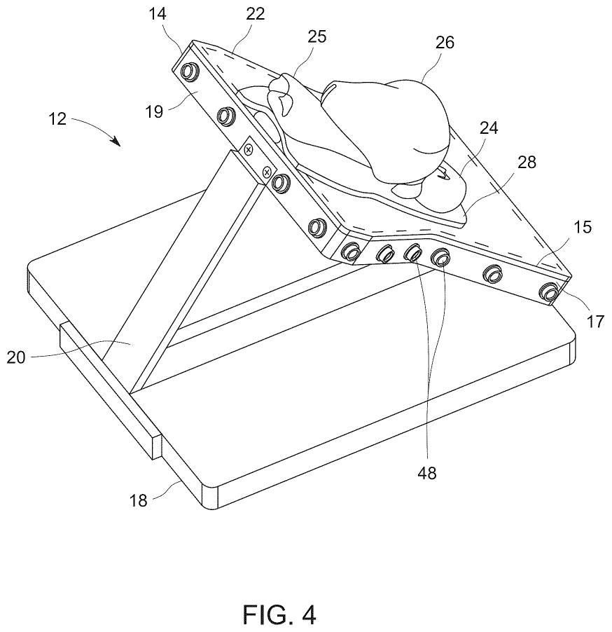

In various embodiments, the support surface 14 is selectively reconfigurable between a first configuration (see FIGS. 2 and 3), in which the support surface 14 extends along a substantially horizontal plane, and a second configuration (see FIGS. 1 and 4), in which one end of the support surface 14 is elevated. For example, in the illustrated embodiment, the support surface 14 is carried by a base 18. A first end 17 of the support surface 14 is rotatably connected to the base 18, as by a hinge or other suitable rotatable connector. An opposite second end 19 of the support surface 14 is selectively engageable by a stand 20 which is configured to support the associated second end 19 of the support surface 14 in an elevated position above the first, hinged end 17. In this regard, in various embodiments, the end of the support surface 14 hinged to the base 18 corresponds with a “cranial” end of the model 10, and the end of the support surface 14 engageable by the stand 20 corresponds with a “cauldal” end of the model 10. Thus, configuration of the support surface 14 in the first, horizontal, configuration results in the model 10 being oriented in a “supine” position, while configuration of the support surface 14 in the second, sloped, configuration results in the model 10 being oriented in a tail-elevated or “Trendelenburg” position.

In the illustrated embodiment, a base layer 22 is provided along an upper surface of the support surface 14, extending along the perimeter area. In various embodiments, the base layer 22 has at least one, and preferably multiple features and characteristics selected to resemble an interior dorsal surface of an abdominal cavity of a small ruminant animal. For example, in the illustrated embodiment, the base layer 22 is comprised of a layer of soft, flexible rubberized material having a generally pink or “flesh-toned” color along its upper surface, opposite the support surface 14. In the illustrated embodiment, the base layer 22 is fabricated from silicone rubber. However, those of skill in the art will recognize numerous materials suitable for use in fabricating the base layer 22, and such materials may be used without departing from the spirit and scope of the present general inventive concept.

As discussed above, in various embodiments, one or more replica organs 24, 26 of an interior abdominal portion of an animal may be provided along the support surface 14 to resemble an interior abdominal cavity of the animal. For example, in the illustrated embodiment, an artificial uterus 24 is provided mounted along the base layer 22 in an orientation corresponding to the naturally occurring orientation of a real uterus within the abdominal cavity of a small ruminant animal. Similar to the base layer 22, the uterus 24 has at least one, and preferably multiple, features and characteristics selected to resemble an actual uterus a small ruminant animal. For example, in the illustrated embodiment, the uterus 24 is shaped to resemble a uterus a small ruminant animal, having a lower (cauldal) “vaginal canal” portion, a central “uterine body” portion extending cranially from the vaginal canal portion, and a pair of “uterine horns” extending in a Y-shape outwardly from a cranial end of the uterine body portion. In more discreet embodiments, the uterus 24 may further define fallopian tube portions extending from the uterine horns, as well as ovaries extending from the fallopian tubes.

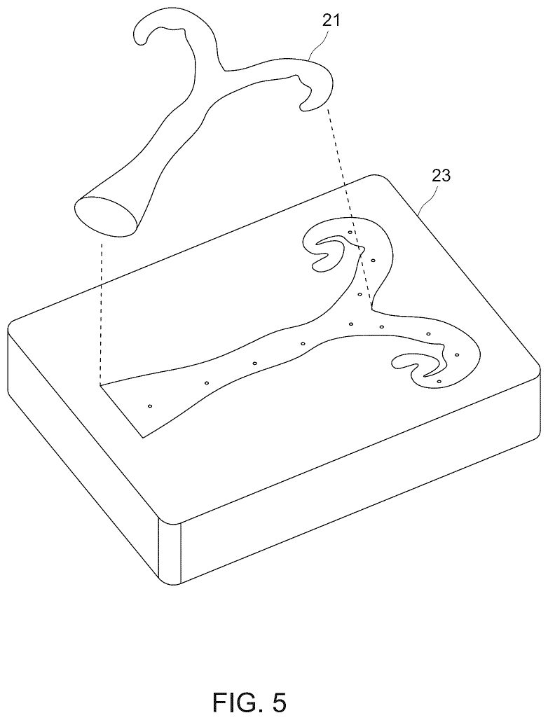

In the illustrated embodiment, the uterus 24 is formed from a substantially rigid central portion 21 covered in a substantially soft, flexible rubberized material, of the typed used in fabricating the base layer 22. More specifically, in the illustrated embodiment, the central portion 21 of the uterus 24 is formed from a substantially rigid plastic material, such as for example polyvinyl chloride (PVC), while an outer surface of the uterus 24 is formed of soft, flexible silicone rubber having a generally pink or “flesh-toned” color along its upper surface, similar to the base layer 22. In this regard, FIG. 5 illustrates various apparatus and processes associated with a method of fabrication of the uterus 24. In various embodiments of a fabrication method, the central portion 21 of the uterus 24 may first be fabricated as by three-dimensional printing, casting, carving, or other means known to one of skill in the art. Thereafter, the outer surface of the uterus 24 may be formed around the central portion as by casting in a mold 23, spray application, or the like. Those of skill in the art will recognize numerous materials and fabrication techniques which may be used to form the uterus 24, and such techniques and materials may be used without departing from the spirit and scope of the present general inventive concept.

In various embodiments, in addition to the uterus 24, one or more additional replica internal organs are provided along the base layer 22 to resemble one or more additional internal organs present in the abdominal cavity of a small ruminant animal. For example, in the illustrated embodiment, a bladder 26 is provided in overlying relationship to the vaginal canal 25 and central uterine body portions 27 of the uterus 24. The bladder 26 is formed of a substantially flexible and slightly translucent material, such that it resembles the approximate size, shape, texture, and appearance of an actual bladder of a small ruminant. Additional replica internal organs may also be provided in other embodiments.

In the illustrated embodiment, both the uterus 24 and the bladder 26 are mounted to a mounting layer 28, which is in turn mounted along the base layer 22 such that the uterus 24 and the bladder 26 are positioned in approximately anatomically correct orientation with respect to the base layer 22 and support surface 14. In the illustrated embodiment, the mounting layer 28 is held to the base layer 22, and the base layer 22 is in turn held to the support surface 14 by a plurality of staples 29. However, it will be recognized that numerous fasteners, adhesives, etc., exist which may be suitable for mounting the various layers, and such additional devices and materials may be used without departing from the spirit and scope of the present general inventive concept.

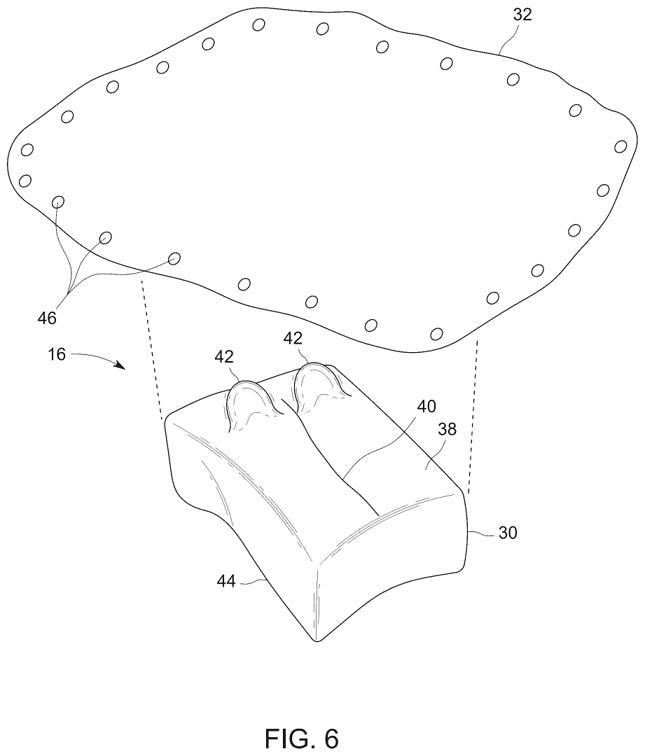

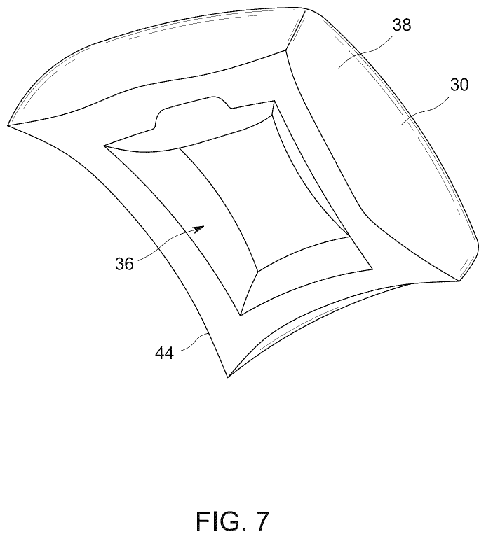

FIGS. 6-7 illustrate one embodiment of a cover portion 16 constructed in accordance with various features of the present general inventive concept. In various embodiments, the above-discussed cover portion 16 consists essentially of a substantially hollow box or container having an exterior surface approximately sized and shaped to resemble an exterior of an abdominal portion of an animal, such as a small ruminant, for example an ovine, and an interior surface approximately sized and shaped to resemble an interior of an abdominal cavity of a small ruminant that has been inflated in preparation for LAI. For example, in the illustrated embodiment, the cover portion 16 includes an interior shell 30 fabricated from open cell foam material. The shell 30 defines an inner concave surface 36 having the approximate size and shape of the interior of an abdominal cavity of a small ruminant that has been inflated in preparation for LAI. An exterior surface 38 of the shell 30 defines a shape approximating that of an exterior of an abdominal portion of a small ruminant. For example, in the illustrated embodiment, the exterior surface 38 of the shell 30 is shaped to resemble an exterior abdominal portion of a small ruminant defining a slightly concave centerline 40 and a plurality of mounds 42 shaped to resemble mammary organs or “teats” of a small ruminant.

As shown in FIGS. 6 and 7, the shell 30 defines an open lower surface allowing access to the inner concave surface 36. A perimetral edge 44 of the shell 30, along an interface of the inner and exterior surfaces 36, 38, is sized and shaped to correspond with and conform to the perimeter area 15 of the support surface 14. Thus, the shell 30 may be positioned over the uterus 24, bladder 26, and other replica organs, with the perimetral edge 44 of the shell 30 conforming along the perimeter area 15 of the support surface 14, such that the shell 30 serves to at least partially, and preferably fully, receive, enclose, and contain the uterus 24, bladder 26, and other replica organs within a cavity formed between the base layer 22, the mounting surface 28, and the interior surface 36 of the shell 30. In this manner, the shell 30 serves to replicate the “abdominal wall” of a small ruminant animal that has been inflated in anticipation of laproscopic surgery.

In the illustrated embodiment, the shell 30 is further covered with an exterior covering 32. The exterior covering 32 is a layer of material fabricated from one or more materials selected to resemble an exterior surface of a small ruminant animal. For example, in the illustrated embodiment, the exterior covering 32 is fabricated from a soft, flexible silicone rubber having a generally pink or “flesh-toned” color along its upper surface, similar to the above-discussed base layer 22 and internal organs. However, those of skill in the art will recognize numerous materials suitable for use in fabricating the exterior covering 32, and such materials may be used without departing from the spirit and scope of the present general inventive concept.

In various embodiments, the components of the cover portion 16 are removably connected to one another, and to the various components of the support surface 14, such that the various components of the model 10 may be disassembled from one another for cleaning, maintenance, and/or replacement of component parts. For example, in various embodiments, the shell 30 is configured to be positioned over the perimeter area of the support surface 14, and the exterior covering 32 is held along a perimeter edge thereof to an outer perimeter of the support surface 14 via a plurality of releasable fasteners, such as for example the illustrated snap fasteners 46, 48. Thus, the exterior covering 32 may be released from the support surface 14, whereupon the cover portion 16 may be removed from the support surface 14 and associated replica organs. The replica organs, shell 30, exterior covering 32, or base layer 22 may then be cleaned, repaired, replaced, etc., without the need for destructive disassembly. In additional applications, the cover portion 16 may be removed from the support surface 14 and associated replica organs to expose the replica organs for viewing, such as for use in teaching demonstrations, exhibits, etc. In still other applications, the cover portion 16 may be removed from the support surface 14 and the various replica organs 24, 26 may be repositioned or replaced to vary the simulated anatomy or positioning of the organs within the model 10, for example, to vary the user difficulty level of the model 10.

In certain embodiments, one or more trocar devices 34 may be provided received through the shell 30 and exterior covering 32 of the cover portion 16. The trocar devices 34 are of the type commonly used in LAI procedures and may provide access to an interior of the cover portion 16 for various other laparoscopic tools. In the illustrated embodiment, two trocar devices 34 are provided at spaced apart, side-by-side orientation slightly offset in the cranial direction in relation to the above-discussed replica mammary organs 42, symmetrically about the centerline 40 of the abdomen. Thus, the trocar devices 34 are positioned to allow convenient access to the uterus 24 for simulation of LAI or other reproductive-oriented laproscopic surgeries. However, it will be recognized that greater or fewer trocar devices 34 may be provided and that the trocar devices 34 may be arranged in different orientations to accommodate different uses of the model 10. For example, in another embodiment, the trocar devices 34 may be positioned in a more caudal location along the length of the abdomen to provide more convenient access to other replica organs contained within the model 10.

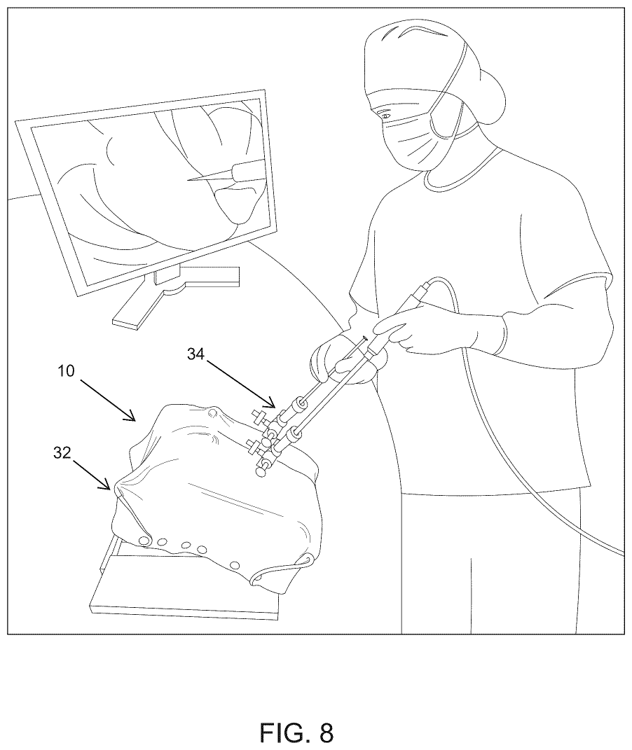

FIG. 8 illustrates various operations associated with one method of use of the model 10. As shown in FIG. 8, in use, the model 10 may be positioned at a desired orientation by elevating one end of the support surface 14 in relation to the other as described above. Thereafter, one or more trocar devices 34 may be positioned through the shell 30 and exterior covering 32 of the cover portion 16 to provide access to the interior of the cover portion 16 for various other laparoscopic tools. One or more laparoscopic tools may be inserted through the trocar devices, whereupon a user may practice one or more laparoscopic procedures using on or more of the artificial organs represented within the cover portion. For example, a user may practice an artificial insemination procedure by inserting a laparoscope or other fiberoptic camera through a first of the trocar devices 34, an injection tool through a second of the trocar devices 34, using the fiberoptic camera to orient the injection tool, and piercing the uterus 24 with the injection tool in a manner simulating the delivery of artificial insemination into the uterus 24. For example, the user may advance the laparoscope through a first of the trocar devices 34 and the injection tool through a second of the trocar devices 34. The user may then use the laparoscope to establish endoscopic visualization of the various organs within the model 10 and use the endoscopic visualization to assist in contacting and piercing the artificial uterus 24 with the injection tool at a location corresponding to a uterine body 27 or horn to simulate intrauterine semen deposition. In various embodiments, the user may, at various times throughout the simulated procedure, adjust a trocar insertion angle or a trocar insertion depth using indicators on the trocar devices 34 to simulate safe technique for insertion of one or more of the laparoscopic tools. Those of skill in the art will recognize numerous other procedures which may be simulated and/or replicated using the model 10, and such procedures may be practiced without departing from the spirit and scope of the present general inventive concept.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A training model for laparoscopic procedures of an animal, comprising:
a base portion including a support surface having a mounting region sized and shaped to correspond to a durasl-ventral outline of an abdominal region of the animal, the mounting region being configured to resemble an internal dorsal surface of an abdominal cavity of the animal;
at least one replica organ mounted along the mounting region in an anatomically corresponding orientation; and
a cover portion including an interior shell defining an inner concave surface sized and shaped to resemble an inflated abdominal cavity and an exterior surface sized and shaped to resemble an exterior abdominal surface of the animal, the exterior surface being configured to resemble an external skin surface of the animal.

2. The training model of claim 1, wherein the support surface is reconfigurable between a substantially horizontal supine orientation and a tail-elevated Trendelenburg orientation by elevating a caudal end of the support surface relative to a cranial end of the support surface.

3. The training model of claim 2, further comprising a hinge at the cranial end and a positionable stand at the caudal end to set an inclination of the support surface corresponding to a Trendelenburg angle.

4. The training model of claim 1, wherein the at least one replica organ includes an artificial uterus comprising a rigid central core and a soft, flexible outer layer having a flesh-toned coloration.

5. The training model of claim 4, wherein the artificial uterus comprises a vaginal canal portion, a uterine body, and a pair of uterine horns extending in a Y-shaped configuration.

6. The training model of claim 5, wherein the artificial uterus further comprises fallopian tubes and ovaries positioned at cranial ends of the uterine horns.

7. The training model of claim 1, wherein the interior shell comprises open-cell foam that defines a concave inner surface approximating the inflated abdominal cavity size and shape.

8. The training model of claim 1, wherein the cover portion is removably fastened to the base portion with releasable fasteners.

9. The training model of claim 1, wherein the at least one replica organ includes a flexible and at least partially translucent artificial bladder.

10. The training model of claim 1, wherein the base portion further comprises a compliant base layer overlying the support surface to replicate an interior dorsal abdominal surface.

11. The training model of claim 1, wherein the support surface has a planform perimeter approximating a dorsal-ventral outline of a small ruminant abdomen.

12. The training model of claim 1, further comprising at least one trocar device received through the cover portion to provide access to an interior of the cover portion for laparoscopic tools.

13. The training model of claim 1, wherein the at least one trocar device includes two trocar devices sized to receive a laparoscope and an injection tool for simulated intrauterine deposition.

14. The training model of claim 1, wherein the cover portion includes an exterior covering over the shell configured to resemble an external skin surface.

15. The training model of claim 14, wherein the exterior covering comprises a soft, flexible elastomer having a flesh-toned coloration to simulate abdominal wall puncture and instrument handling.

16. The training model of claim 1, wherein the replica organs and cover portion are modular and replaceable to vary anatomy, positioning, or user difficulty level.

17. The training model of claim 1, wherein the apparatus is sized and configured to accept insertion of a fiberoptic camera through a first trocar and an injection tool through a second trocar to simulate guided intrauterine injection.

18. A method of training laparoscopic artificial insemination in a female small ruminant using a simulation apparatus, the method comprising:
configuring a base portion and cover portion of the apparatus to encapsulate replica organs including an artificial uterus and a bladder within an interior cavity that simulates a gas-inflated abdominal cavity;
positioning the apparatus in a supine or tail-elevated Trendelenburg orientation;
inserting at least one trocar device through an exterior of the cover portion into the interior cavity;
advancing a laparoscope through a first trocar and an injection tool through a second trocar; and
under endoscopic visualization, contacting and piercing the artificial uterus with the injection tool at a location corresponding to a uterine body or horn to simulate intrauterine semen deposition.

19. The method of claim 18, further comprising adjusting a trocar insertion angle and a trocar insertion depth using indicators on a trocar device to simulate safe insertion technique.

20. A kit for assembling a small-ruminant laparoscopic artificial insemination training model, comprising:
a support surface configured to reconfigure between supine and Trendelenburg orientations;
a base layer;
a mounting layer;
a set of replica organs including an artificial uterus having a rigid core and a soft outer layer and a flexible bladder;
an interior shell shaped to define an inflated abdominal cavity;
an exterior covering sized to replicate an abdominal wall; and
at least two trocar devices sized for a laparoscope and an injection tool;
wherein the components are removably connectable to enable assembly, disassembly, cleaning, and replacement while maintaining an anatomically representative arrangement for laparoscopic artificial insemination training.
